(19) United States
(12) Patent Application Publication
(10) Pub. No.: US 2021/0192758 A1
(43) Pub. Date: Jun. 24, 2021

(54) IMAGE PROCESSING METHOD AND APPARATUS, ELECTRONIC DEVICE, AND COMPUTER READABLE STORAGE MEDIUM

(71) Applicant: SHANGHAI SENSETIME INTELLIGENT TECHNOLOGY CO., LTD., Shanghai (CN)

(72) Inventor: Tao SONG, Shanghai (CN)

(21) Appl. No.: 17/194,790

(22) Filed: Mar. 8, 2021

Related U.S. Application Data
(63) Continuation of application No. PCT/CN2019/120329, filed on Nov. 22, 2019.

(30) Foreign Application Priority Data
Dec. 27, 2018 (CN) 201811614468.4

(51) Int. Cl. G06T 7/32; G06T 3/00

(52) U.S. Cl. CPC G06T 7/32; G06T 3/0068; G06T 2207/10081; G06T 2207/20081; G06T 2207/20084

(57) ABSTRACT

An image processing method and apparatus, an electronic device, and a computer-readable storage medium are provided. The method includes: a to-be-registered image and a reference image used for registration are obtained; the to-be-registered image and the reference image are input into a preset neural network model, where a target function for measuring similarity in training of the preset neural network model includes correlation coefficient loss of a preset to-be-registered image and a preset reference image; and the to-be-registered image is registered with the reference image based on the preset neural network model to obtain a registration result.

### CROSS-REFERENCE TO RELATED APPLICATION

This is a continuation application of International Patent Application No. PCT/CN2019/120329, filed on Nov. 22, 2019, which claims priority to China Patent Application No. 201811614468.4, filed to the Chinese Patent Office on Dec. 27, 2018 and entitled “Image Processing Method and Apparatus, Electronic Device, and Computer-Readable Storage Medium”. The disclosures of PCT/CN2019/120329 and 201811614468.4 are hereby incorporated by reference in their entireties.

### BACKGROUND

Image registration refers to a process of registering two or more images of the same scenario or the same target under different acquisition time, different sensors and different conditions, and is extensively applied to medical image processing processes. Medical image registration is an important technology in the field of medical image processing and plays a more and more important role in clinical diagnosis and treatment.

### SUMMARY

The disclosure relates to the technical field of computer vision, and particularly to an image processing method and apparatus, an electronic device, and a computer-readable storage medium.

Embodiments of the application provide an image processing method and apparatus, an electronic device, and a computer-readable storage medium.

A first aspect of the embodiments of the application provides an image processing method, which may include the following operations.

A moving image and a fixed image used for registration are acquired.

The moving image and the fixed image are input to a preset neural network model, a target function for similarity measurement in the preset neural network model including a loss of a correlation coefficient for a preset moving image and a preset fixed image.

The moving image is registered to the fixed image based on the preset neural network model to obtain a registration result.

A second aspect of the embodiments of the application provides an image processing apparatus, which may include an acquisition module and a registration module.

The acquisition module may be configured to acquire a moving image and a fixed image used for registration.

The registration module may be configured to input the moving image and the fixed image to a preset neural network model, a target function for similarity measurement in the preset neural network model including a loss of a correlation coefficient for a preset moving image and a preset fixed image.

The registration module may further be configured to register the moving image to the fixed image based on the preset neural network model to obtain a registration result.

A third aspect of the embodiments of the application provides an electronic device, which may include a processor and a memory. The memory may be configured to store one or more programs, the one or more programs may be configured to be executed by the processor, and the program may be configured to execute part or all of the operations described in any method of the first aspect of the embodiments of the application.

A fourth aspect of the embodiments of the application provide a computer-readable storage medium, which may be configured to store computer programs for electronic data exchange, the computer programs enabling a computer to execute part or all of the operations described in any method of the first aspect of the embodiments of the application.

A fifth aspect of the embodiments of the application provides a computer program, which may include computer-readable codes, the computer-readable codes running in an electronic device to enable a processor in the electronic device to execute the abovementioned method.

### BRIEF DESCRIPTION OF THE DRAWINGS

In order to describe the technical solutions in the embodiments of the application or a conventional art more clearly, the drawings required to be used in descriptions about the embodiments or the conventional art will be simply introduced below.

FIG. 1 is a flowchart of an image processing method according to embodiments of the application.

FIG. 2 is a flowchart of a training method for a preset neural network model according to embodiments of the application.

FIG. 3 is a structure diagram of an image processing apparatus according to embodiments of the application.

FIG. 4 is a structure diagram of an electronic device according to embodiments of the application.

### DETAILED DESCRIPTION

According to the embodiments of the application, the moving image and the fixed image used for registration are acquired, the moving image and the fixed image are input to the preset neural network model, the target function for similarity measurement in the preset neural network model including the loss of the correlation coefficient for the preset moving image and the preset fixed image, and the moving image is registered to the fixed image based on the preset neural network model to obtain the registration result, so that the accuracy and real-time performance of image registration may be improved.

In order to make the solutions of the disclosure understood by those skilled in the art, the technical solutions in the embodiments of the application will be clearly and completely described below in combination with the drawings in the embodiments of the application. It is apparent that the described embodiments are not all embodiments but only part of embodiments of the disclosure. All other embodiments obtained by those of ordinary skill in the art based on the embodiments in the disclosure without creative work shall fall within the scope of protection of the disclosure.

Terms “first”, “second” and the like in the specification, claims and drawings of the disclosure are adopted not to describe a specific sequence but to distinguish different objects. In addition, terms “include” and “have” and any transformations thereof are intended to cover nonexclusive inclusions. For example, a process, method, system, product or device including a series of steps or units is not limited to the steps or units which have been listed but optionally further includes steps or units which are not listed or optionally further includes other steps or units intrinsic to the process, the method, the product or the device.

“Embodiment” mentioned herein means that a specific feature, structure or characteristic described in combination with an embodiment may be included in at least one embodiment of the disclosure. Each position where this phrase appears in the specification does not always refer to the same embodiment as well as an independent or alternative embodiment mutually exclusive to another embodiment. It is explicitly and implicitly understood by those skilled in the art that the embodiments described in the disclosure may be combined with other embodiments.

An image processing apparatus involved in the embodiments of the application is accessible to multiple other terminal devices. The image processing apparatus may be an electronic device, including a terminal device. During specific implementation, the terminal device includes, but not limited to, another portable device like a mobile phone, laptop computer or tablet computer with a touch sensitive surface (for example, a touch screen display and/or a touch pad). It is also to be understood that, in some embodiments, the device is not a portable communication device but a desktop computer with a touch sensitive surface (for example, a touch screen display and/or a touch pad).

The concept of deep learning in the embodiments of the application originates from researches of artificial neural networks. A multilayer perceptron including multiple hidden layers is a deep learning structure. Deep learning combines low-layer features to form more abstract high-layer representation attribute types or features to discover distributed feature representations of data.

Deep learning is a data representation learning method in machine learning. An observed value (for example, an image) may be represented in multiple manners, for example, represented as a vector of an intensity value of each pixel or represented more abstractly as a series of sides and a region in a specific shape. Adopting some specific representation methods may learn tasks (for example, face recognition or facial expression recognition) from examples more easily. Deep learning has an advantage that manual feature acquisition is replaced with an efficient unsupervised or semi-supervised feature learning and layered feature extraction algorithm. Deep learning is a novel field in researches of machine learning and aims to constructing a neural network that simulates a brain for analytic learning, and a brain mechanism is simulated to explain data such as an image, a sound and a text.

The embodiments of the application will be introduced below in detail.

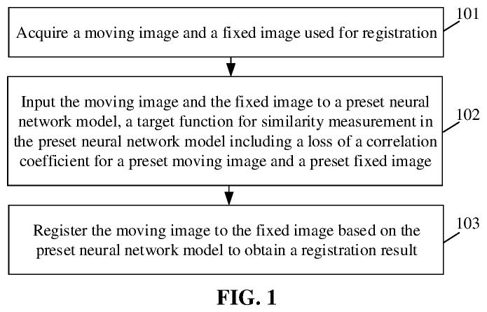

Referring to FIG. 1, FIG. 1 is a flowchart of an image processing method according to embodiments of the application. As shown in FIG. 1, the image processing method may be executed by the abovementioned image processing apparatus, and includes the following operations.

In 101, a moving image and a fixed image used for registration are acquired.

Image registration refers to a process of registering two or more images of the same scenario or the same target under different acquisition time, different sensors and different conditions, and is extensively applied to medical image processing processes. Medical image registration is an important technology in the field of medical image processing and plays a more and more important role in clinical diagnosis and treatment. Modern medicine usually requires medical images obtained in multiple modes or at multiple time points to be comprehensively analyzed, so it is necessary to register a few images before analysis.

Both the moving image and fixed image used for registration mentioned in the embodiments of the application may be medical images obtained by various medical image devices, and may particularly be deformable organ images, for example, Computerized Tomography (CT) images of the lung. The moving image and the fixed image used for registration are usually images, collected at different time points or under different conditions, of the same organ, and a moved image may be obtained by registration.

A medical image required to be registered may be diverse, which may be reflected as that a feature, such as an image gray value, an image size of the image and the like, is diverse. Optionally, before 101, an original moving image and an original fixed image may be acquired, and image normalization processing may be performed on the original moving image and the original fixed image to obtain a moving image and fixed image meeting a target parameter.

The target parameter may be understood as a parameter describing an image feature, i.e., a specified parameter configured to achieve a uniform style of original image data. For example, the target parameter may include a parameter configured to describe a feature such as an image resolution, an image gray, an image size and the like.

The original moving image may be a medical image obtained by various medical image devices, may particularly be a deformable organ image, and is diverse, reflected as that a feature, such as an image gray value, image size of the image, and the like, is diverse. Before registration, some basic preprocessing may be performed on the original moving image and the original fixed image, or preprocessing may be performed on the original moving image only. The preprocessing may include image normalization processing. A main purpose of image preprocessing is to eliminate unrelated information in the image, recover useful real information, enhance the detectability of related information and maximally simplify data, thereby improving the reliability of feature extraction, image segmentation, matching and recognition.

Image normalization in the embodiments of the application refers to a process of performing a series of standard processing transformations on the image to convert it to a fixed standard form, and the standard image is called a normalized image. Image normalization may find a set of parameters by use of an invariant moment of the image to eliminate the influences of other transformation functions on image transformation and convert the to-be-processed original image to a corresponding unique standard form, and an image in the standard form has an invariant feature with respect to affine transformation such as translation, rotation, scaling and the like. Therefore, through the above image normalization processing, images of the uniform style may be obtained, and the stability and accuracy of subsequent processing may be improved.

Optionally, the moving image and the fixed image may also be masks or feature points extracted through an algorithm. The mask may be understood as a template of an image filter. Image masking may be understood as occluding a processing image (completely or partially) by use of a selected image, graph or object to control an image processing region or a processing process. In digital image processing, a mask usually may be a two-dimensional matrix array, sometimes may also be a multivalued image, and may be configured for structural feature extraction.

After feature or mask extraction, interference in image processing may be reduced, and a registration result is more accurate.

Specifically, the original moving image may be converted to a moving image with a preset image size and in a preset gray value range.

The original fixed image is converted to a fixed image with the preset image size and in the preset gray value range.

The image processing apparatus in the embodiments of the application may store the preset gray range and the preset image size. A resampling operation may be executed through simple Inside Segmentation and Registration Toolkit (ITK) software to keep positions and resolutions of the moving image and the fixed image substantially consistent. ITK is an open-source cross-platform system and provides a set of software tools for developers for image analysis.

The preset image size may be 416×416×80. Image sizes of the moving image and the fixed image may be unified to be 416×416×80 through a cropping or padding (zero-padding) operation.

Preprocessing the original image data may reduce the diversity thereof, and thus the neural network model may make a more stable judgment.

Registering two medical images 1 and 2 acquired at different time and/or under different conditions refers to seeking a mapping relationship P which enables that each point in the image 1 corresponds to a unique point in the image 2. The two points corresponding to the same anatomical position. The mapping relationship P is represented as a group of continuous spatial transformations. Common spatial geometric transformation includes rigid body transformation, affine transformation, projective transformation and nonlinear transformation.

Rigid body transformation refers to that a distance and parallel relationship between any two points in an object are kept unchanged. Affine transformation, the simplest non-rigid transformation, refers to a transformation that keeps the parallelism but is non-conformal and changes the distance. In many important clinical applications, a deformable image registration method is often required to be used. For example, when studying the image registration for abdominal and thoracic organs, since positions, sizes and shapes of inner organs and tissues are changed by physiological movements or movement of patients, it is necessary to compensate image deformations by deformable transformation.

In the embodiments of the application, the preprocessing may further include the rigid body transformation, namely rigid body transformation is performed on the image at first, and then image registration is implemented according to the methods in the embodiments of the application.

In the field of image processing, transformation implemented by changing a position (translation transformation) and orientation (rotation transformation) of an object only but keeping a shape unchanged is called rigid body transformation.

In 102, the moving image and the fixed image are input to a preset neural network model, a target function for similarity measurement in the preset neural network model including a loss of a correlation coefficient for a preset moving image and a preset fixed image.

In the embodiments of the application, the image processing apparatus may store the preset neural network model, and the preset neural network model may be obtained by pretraining.

The preset neural network model may be obtained by training based on the loss of the correlation coefficient, and may specifically be obtained by training based on taking the loss of the correlation coefficient for the preset moving image and the preset fixed image as the target function for similarity measurement.

The correlation coefficient mentioned in the embodiments of the application is a statistical index first designed by the statistician Karl Pearson as well as a parameter for researching a linear correlation degree between variables, and is usually represented by letter r. For different research objects, multiple defining manners are adopted for the correlation coefficient, and a Pearson correlation coefficient is commonly used.

The correlation coefficient is usually calculated according to a product moment method. Based on dispersions between two variables and respective averages, the two dispersions are multiplied to reflect a correlation degree between the two variables. A linear simple correlation coefficient is emphatically researched. It is to be noted that the Pearson correlation coefficient is not the only correlation coefficient but a common correlation coefficient. The correlation coefficient in the embodiments of the application may be the Pearson correlation coefficient.

Specifically, feature maps of a moved image and the preset fixed image may be extracted in the preset neural network model, and the loss of the correlation coefficient is obtained by use of a cross correlation coefficient for the feature maps.

The loss of the correlation coefficient may be obtained based on the following formula (1):

$$CC ( F , M ( φ ) ) = {\sum }_{p ∈ Q} \frac{{( {\sum }_{pi} ( F ( pi ) - \hat{F} ( p ) ) ( M ( φ ( pi ) ) - \hat{M} ( φ ( p ) ) ) )}^{2}}{( {\sum }_{pi} ( F ( pi ) - \hat{F} ( p ) ) ) ( {\sum }_{pi} ( M ( φ ( pi ) ) - \hat{M} ( φ ( pi ) ) ) )} . \qquad ( 1 )$$

F may represent the preset fixed image, M(ϕ) may represent the moved image, and ϕ may represent a nonlinear relationship represented by a neural network. \hat{M} and \hat{F} with the upper triangular symbol may represent an average of the moved image and a parameter average of the preset fixed image respectively. For example, \hat{F} represents the parameter average of the preset fixed image, and then subtraction (F(pi)−\hat{F}(p)) may be understood as subtraction of the parameter average from each pixel value of the preset fixed image, and so on.

A training process for the preset neural network model may include the following operations.

The preset moving image and the preset fixed image are acquired, and the preset moving image and the preset fixed image are input to the preset neural network model to generate a deformable field.

The preset moving image is registered to the preset fixed image based on the deformable field to obtain a moved image.

A loss of a correlation coefficient for the moved image and the preset fixed image is obtained.

Parameter updating is performed on the preset neural network model based on the loss of the correlation coefficient to obtain a trained preset neural network model.

Specifically, a loss function for the deformable field may include an L2 loss function such that the preset neural network model learns an appropriate deformable field to make the moved image and the fixed image more similar.

In 103, the moving image is registered to the fixed image based on the preset neural network model to obtain a registration result.

Image registration is usually implemented as follows: feature extraction is performed on two images to obtain feature points at first; then similarity measurement is performed to find a matched feature point pair; next, an image space coordinate transformation parameter is obtained through the matched feature point pair; and finally, image registration is performed through the coordinate transformation parameter.

In the embodiments of the application, a convolutional layer of the preset neural network model may adopt Three-Dimensional (3D) convolution. The deformable field is generated through the preset neural network model, and then deformable transformation is performed, through the 3D spatial transformation layer, on the moving image required to be deformed to obtain the registration result after registration, namely including the generated moved image.

In the preset neural network model, L2 loss and the correlation coefficient are taken as the loss function, so that the deformable field may be smooth, and meanwhile, high registration accuracy may be achieved.

An existing method is to implement registration by use of supervised deep learning. There are substantially no golden standards. A conventional registration method is required to obtain a label. The processing time is relatively long, and the registration accuracy is limited. Moreover, the conventional registration method requires calculation of a transformation relationship of each pixel, so that the calculation burden is heavy, and the time consumption is also high.

Solving various problems in pattern recognition according to training samples of unknown categories (unlabeled) is called unsupervised learning. In the embodiments of the application, image registration is implemented by use of an unsupervised deep learning-based neural network, and the embodiments may be applied to registration of any deformable organ. In the embodiments of the application, the method may be executed by use of a Graphics Processing Unit (GPU) to obtain the registration result in a few seconds, and higher efficiency is achieved.

According to the embodiments of the application, the moving image and the fixed image used for registration are acquired, the moving image and the fixed image are input to the preset neural network model, the target function for similarity measurement in the preset neural network model including the loss of the correlation coefficient for the preset moving image and the preset fixed image, and the moving image is registered to the fixed image based on the preset neural network model to obtain the registration result, so that the accuracy and real-time performance of image registration may be improved.

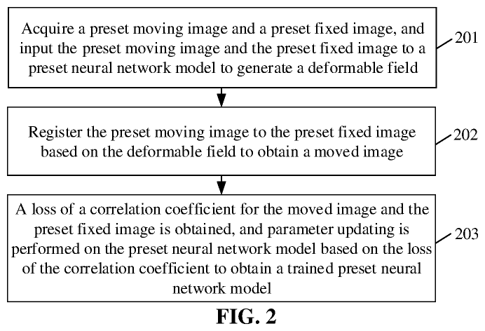

Referring to FIG. 2, FIG. 2 is a flowchart of another image processing method according to embodiments of the application, specifically a flowchart of a training method for a preset neural network. FIG. 2 is obtained by further optimization based on FIG. 1. An execution body for the operations of the embodiments of the application may be an image processing apparatus, which may be the same as or different from the image processing apparatus in the method of the embodiments shown in FIG. 1. As shown in FIG. 2, the image processing method includes the following operations.

In 201, a preset moving image and a preset fixed image are acquired, and the preset moving image and the preset fixed image are input to a preset neural network model to generate a deformable field.

Like the embodiments shown in FIG. 1, both the preset moving image (moving) and the preset fixed image (fixed) may be medical images obtained by various medical image devices, and may particularly be deformable organ images, for example, CT images of the lung. A moving image and a fixed image used for registration are usually images, collected at different time points or under different conditions, of the same organ. The term “preset” is used for distinguishing from the moving image and fixed image in the embodiments shown in FIG. 1. Herein, the preset moving image and the preset fixed image are mainly configured as an input of the preset neural network model to train the preset neural network model.

A medical image required to be registered may be diverse, which may be reflected as that a feature, such as an image gray value, image size of the image, and the like, is diverse. Optionally, after the operation that the preset moving image and the preset fixed image are acquired, the method may further include the following operation.

Image normalization processing is performed on the preset moving image and the preset fixed image to obtain a preset moving image and preset fixed image meeting a preset training parameter.

The operation that the preset moving image and the preset fixed image are input to the preset neural network model to generate the deformable field includes the following operation.

The preset moving image and preset fixed image meeting the preset training parameter are input to the preset neural network model to generate the deformable field.

The preset training parameter may include a preset gray value range and a preset image size (for example, 416×416×80). The image normalization processing process may refer to the specific descriptions in 101 in the embodiments shown in FIG. 1. Optionally, preprocessing before registration may include rigid body transformation. Specifically, a resampling operation may be executed through simple ITK software to keep positions and resolutions of the preset moving image and the preset fixed image substantially consistent. For convenient operations in a subsequent training process, the image may be cropped or padded according to a predetermined size. If the preset image size of the input image is 416×416×80, it is necessary to unify image sizes of the preset moving image and the preset fixed image to be 416×416×80 through a cropping or padding (zero-padding) operation.

Optionally, the converted preset moving image and the converted preset fixed image may be processed according to a target window width to obtain a processed preset moving image and a processed preset fixed image.

Different organic tissues have different performances in CT, that is, corresponding gray levels may be different. Windowing refers to a process of calculating an image by use of data obtained by a Hounsfield (inventor) Unit (HU). Different radiodensities correspond to 256 different gray values, and attenuation values may be redefined, according to different CT value ranges, for these different gray values. If a center value of a CT range is kept unchanged, after a definition range is narrowed, called a narrow window, small changes of details may be distinguished. This is called contrast compression on the concept of image processing.

For important information in a CT image of the lung, the target window width may be preset. For example, the preset moving image and the preset fixed image are normalized to [0, 1] through the target window width [4,200, 600], namely a part greater than 600 in the original image is set to be 1 and a part less than −1,200 is set to be 0.

In the embodiments of the application, well-accepted window widths and window levels may be set on CT for different tissues to extract important information better. Herein, specific values −1,200 and 600 in [4,200, 600] represent window levels, and a range thereof, i.e., the window width, is 1,800. Image normalization processing is used for avoiding gradient explosion in subsequent loss calculation.

In the embodiments of the application, a normalization layer is proposed to improve the stability and convergence of training. It may be hypothesized that a size of a feature map is N×C×D×H×W, where N refers to a batch size, i.e., a data size of each batch, C is the number of channels, D is a depth, and H and W are a height and width of the feature map respectively. Optionally, H, W and D may also be parameters representing a length, width and height of the feature map respectively. In different applications, other image parameters may be used for describing the feature map. In the embodiments of the application, a minimum and maximum of C×D×H×W may be calculated to execute a normalization processing operation on each piece of image data.

Optionally, before the operation that the converted preset moving image and the converted preset fixed image are processed according to a preset window width, the method further includes the following operation.

A target category label of the preset moving image is acquired, and the target window width corresponding to the target category label is determined according to a corresponding relationship between a preset category label and a preset window width.

Specifically, the image processing apparatus may store at least one preset window width and at least one preset category label and store the corresponding relationship between the preset category label and the preset window width. The input preset moving image may contain the target category label, or a user may operate the image processing apparatus to select the target category label of the preset moving image. The image processing apparatus may find the target category label from the above preset category labels, determine the target window width, corresponding to the target category label, from the above preset window widths according to the corresponding relationship between the preset category label and the preset window width, and then process the converted preset moving image and the converted preset fixed image according to the target window width.

Through the above operations, the image processing apparatus may rapidly and flexibly select window widths used for processing different preset moving images to facilitate subsequent registration processing.

In 202, the preset moving image is registered to the preset fixed image based on the deformable field to obtain a moved image.

Since L2 is smooth, an L2 loss function may be adopted for a gradient of the deformable field.

The preprocessed preset moving image and the preprocessed preset fixed image are input to a to-be-trained neural network to generate the deformable field, and then the preset moving image is registered to the preset fixed image based on the deformable field, namely a deformed moved image is generated by use of the deformable field and the preset fixed image.

The moved image is an intermediate image obtained by preliminarily registering the preset moving image to the preset fixed image through the preset neural network model. This process may be understood to be executed for many times, namely 202 and 203 may be repeatedly executed to continuously train and optimize the preset neural network model.

In 203, a loss of a correlation coefficient for the moved image and the preset fixed image is obtained, and parameter updating is performed on the preset neural network model based on the loss of the correlation coefficient to obtain a trained preset neural network model.

In the embodiments of the application, a loss of a correlation coefficient is adopted as a similarity evaluation standard for a moved image and a fixed image, and 202 and 203 may be repeatedly executed to continuously update a parameter of the preset neural network model to guide the training for the network.

Optionally, parameter updating of a preset learning rate and a preset threshold count may be performed on the preset neural network model based on a preset optimizer.

The preset threshold count involved in updating refers to an epoch during training for the neural network. An epoch may be understood as a forward propagation and a back propagation of all training samples.

An algorithm used in the optimizer usually includes an Adaptive Gradient (AdaGrad) optimization algorithm and a Root Mean Square Prop (RMSProp) algorithm. The AdaGrad optimization algorithm may regulate different learning rates for different parameters, update parameters that frequently changes according to a smaller step and update sparse parameters according to a larger step. The RMSProp algorithm may regulate learning rates in combination with an exponential moving average of a gradient direction, and may implement convergence well under a non-stationary target function condition.

Specifically, the preset optimizer may adopt an Adaptive Moment Estimation (ADAM) optimizer and combines the advantages of the two optimization algorithms AdaGrad and RMSProp. First moment estimation (i.e., mean of the gradient) and second moment estimation (i.e., uncentralized variance of the gradient) of the gradient are comprehensively considered to calculate an updating step.

The image processing apparatus or the preset optimizer may store the preset threshold count and the preset learning rate to control updating. For example, the learning rate is 0.001, and the preset threshold count is 300 epoch. A learning rate regulation rule may be set, and the learning rate for parameter updating is regulated according to the learning rate regulation rule. For example, it may be set that the learning rate is halved at 40, 120 and 200 epoch respectively.

After the trained preset neural network model is obtained, the image processing apparatus may execute part or all of the method in the embodiments shown in FIG. 1, namely the moving image may be registered to the fixed image based on the preset neural network model to obtain a registration result.

Generally speaking, most technologies adopt a mutual information registration method and require estimation of a density of simultaneous distribution. Estimating mutual information by a non-parametric method (for example, by use of a histogram) is heavy in calculation burden, does not support back propagation and may not be applied to a neural network. In the embodiments of the application, a correlation coefficient of a local window is adopted as a similarity measurement loss, the trained preset neural network model may be configured for image registration, particularly medical image registration of any deformable organ. Deformable registration may be performed on follow-up images of different time points, the registration efficiency is high, and the result is more accurate.

In some operation, it is usually necessary to perform various types of scanning of different quality and speeds before the operation or during the operation to obtain medical images. However, medical image registration may be performed only after various types of scanning are completed, and this does not meet a requirement on real-time performance in the operation. Therefore, additional time is usually required to judge an operation result, and if it is found by registration that the operation result is not so ideal, subsequent operative treatment may be required. For both a doctor and a patient, this may waste time and delay treatment. Registration based on the preset neural network model of the embodiments of the application may be applied to real-time medical image registration in operation, for example, registration is performed in real time in tumor removal operation to judge whether the tumor has been completely removed or not, so that the timeliness is improved.

According to the embodiments of the application, the preset moving image and the preset fixed image are acquired, the preset moving image and the preset fixed image are input to the preset neural network model to generate the deformable field, the preset moving image is registered to the preset fixed image based on the deformable field to obtain the moved image, the loss of the correlation coefficient for the moved image and the preset fixed image is obtained, and parameter updating is performed on the preset neural network model based on the loss of the correlation coefficient to obtain the trained preset neural network model. The embodiments may be applied to deformable registration, and the accuracy and real-time performance of image registration may be improved.

The solutions of the embodiments of the application are introduced mainly from the view of a method execution process. It can be understood that, for realizing the functions, the image processing apparatus includes corresponding hardware structures and/or software modules executing each function. Those skilled in the art may easily realize that the units and algorithm steps of each example described in combination with the embodiments disclosed herein may be implemented by hardware or a combination of the hardware and computer software in the disclosure. Whether a certain function is executed by the hardware or in a manner of driving the hardware by the computer software depends on specific applications and design constraints of the technical solutions. Professionals may realize the described functions for specific applications by use of different methods, but such realization shall fall within the scope of the disclosure.

According to the embodiments of the application, functional modules of the image processing apparatus may be divided according to the abovementioned method example. For example, each functional module may be divided correspondingly to each function and two or more than two functions may also be integrated into a processing module. The integrated module may be implemented in a hardware form and may also be implemented in form of a software function module. It is to be noted that division of the modules in the embodiment of the application is schematic and only logical function division and another division manner may be adopted during practical implementation.

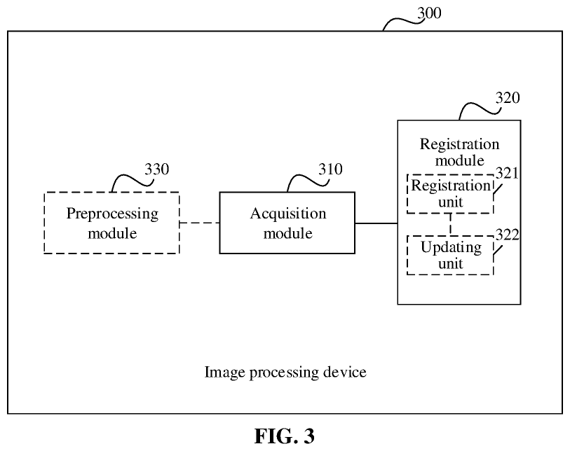

Referring to FIG. 3, FIG. 3 is a structure diagram of an image processing apparatus according to embodiments of the application. As shown in FIG. 3, the image processing apparatus 300 includes an acquisition module 310 and a registration module 320.

The acquisition module 310 is configured to acquire a moving image and a fixed image used for registration.

The registration module 320 is configured to input the moving image and the fixed image to a preset neural network model, a target function for similarity measurement in the preset neural network model including a loss of a correlation coefficient for a preset moving image and a preset fixed image.

The registration module 320 is further configured to register the moving image to the fixed image based on the preset neural network model to obtain a registration result.

Optionally, the image processing apparatus 300 further includes a preprocessing module 330, configured to acquire an original moving image and an original fixed image and perform image normalization processing on the original moving image and the original fixed image to obtain a moving image and fixed image meeting a target parameter.

Optionally, the preprocessing module 330 is specifically configured to:

convert the original moving image to a moving image with a preset image size and in a preset gray value range; and

convert the original fixed image to a fixed image with the preset image size and in the preset gray value range.

Optionally, the registration module 320 includes a registration unit 321 and an updating unit 322.

The registration unit 321 is configured to acquire the preset moving image and the preset fixed image and input the preset moving image and the preset fixed image to the preset neural network model to generate a deformable field.

The registration unit 321 is further configured to register the preset moving image to the preset fixed image based on the deformable field to obtain a moved image.

The updating unit 322 is configured to obtain a loss of a correlation coefficient for the moved image and the preset fixed image, and is configured to perform parameter updating on the preset neural network model based on the loss of the correlation coefficient to obtain a trained preset neural network model.

Optionally, the preprocessing module 330 is further configured to:

perform image normalization processing on the preset moving image and the preset fixed image to obtain a preset moving image and preset fixed image meeting a preset training parameter.

The registration unit 321 is specifically configured to input the preset moving image and preset fixed image meeting the preset training parameter to the preset neural network model to generate the deformable field.

Optionally, the preprocessing module 330 is specifically configured to:

convert a size of the preset moving image and a size of the preset fixed image to the preset image size; and

process the converted preset moving image and the converted preset fixed image according to a target window width to obtain a processed preset moving image and a processed preset fixed image.

Optionally, the preprocessing module 330 is further specifically configured to:

before the converted preset moving image and preset fixed image are processed according to a preset window width, acquire a target category label of the preset moving image and determine the target window width corresponding to the target category label according to a corresponding relationship between a preset category label and a preset window width.

Optionally, the updating unit 322 is further configured to:

perform, based on a preset optimizer, parameter updating for a preset learning rate and a preset threshold count on the preset neural network model.

The image processing apparatus 300 in the embodiments shown in FIG. 3 may execute part or all of the method in the embodiments shown in FIG. 1 and/or FIG. 2.

When the image processing apparatus 300 shown in FIG. 3 is implemented, the image processing apparatus 300 may acquire the moving image and the fixed image used for registration, input the moving image and the fixed image to the preset neural network model, the target function for similarity measurement in the preset neural network model including the loss of the correlation coefficient for the preset moving image and the preset fixed image, and register the moving image to the fixed image based on the preset neural network model to obtain the registration result, so that the accuracy and real-time performance of image registration may be improved.

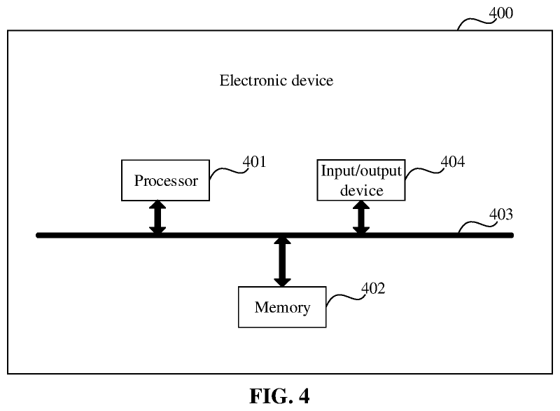

Referring to FIG. 4, FIG. 4 is a structure diagram of an electronic device according to embodiments of the application. As shown in FIG. 4, the electronic device 400 includes a processor 401 and a memory 402. The electronic device 400 may further include a bus 403. The processor 401 and the memory 402 may be connected with each other through the bus 403. The bus 403 may be a Peripheral Component Interconnect (PCI) bus or an Extended Industry Standard Architecture (EISA) bus, etc. The bus 403 may be divided into an address bus, a data bus, a control bus and the like. For convenient representation, only one bold line is adopted for representation in FIG. 4, but it is not indicated that there is only one bus or one type of bus. The electronic device 400 may further include an input/output device 404, and the input/output device 404 may include a display screen, for example, a liquid crystal display screen. The memory 402 is configured to store a one or more programs including instructions. The processor 401 is configured to call the instructions stored in the memory 402 to execute part or all of the steps of the method mentioned in the embodiments shown in FIG. 1 and FIG. 2. The processor 401 may correspondingly realize the functions of each module in the electronic device 300 in FIG. 3.

When the electronic device 400 shown in FIG. 4 is implemented, the electronic device 400 may acquire a moving image and a fixed image used for registration, input the moving image and the fixed image to a preset neural network model, a target function for similarity measurement in the preset neural network model including a loss of a correlation coefficient for the preset moving image and the preset fixed image, and register the moving image to the fixed image based on the preset neural network model to obtain a registration result, so that the accuracy and real-time performance of image registration may be improved.

The embodiments of the application also provide a computer-readable storage medium, which stores computer programs for electronic data exchange, the computer programs enabling a computer to execute part or all of the operations of any image processing method recorded in the method embodiments.

The embodiments of the application also provide a computer program, which includes computer-readable codes, the computer-readable codes running in an electronic device to enable a processor in the electronic device to execute the part or all of the operations of any image processing method recorded in the method embodiments.

It is to be noted that, for simple description, each method embodiment is expressed into a combination of a series of actions. However, those skilled in the art should know that the disclosure is not limited by an action sequence described herein because some steps may be executed in another sequence or at the same time according to the disclosure. Second, those skilled in the art should also know that the embodiments described in the specification all belong to preferred embodiments and involved actions and modules are not always necessary to the disclosure.

Each embodiment in the abovementioned embodiments is described with different emphases, and undetailed parts in a certain embodiment may refer to related descriptions in the other embodiments.

In some embodiments provided by the application, it is to be understood that the disclosed device may be implemented in another manner. For example, the device embodiment described above is only schematic, and for example, division of the modules (or units) is only logic function division, and other division manners may be adopted during practical implementation. For example, multiple modules or components may be combined or integrated into another system, or some characteristics may be neglected or not executed. In addition, coupling or direct coupling or communication connection between each displayed or discussed component may be indirect coupling or communication connection, implemented through some interfaces, of the device or the modules, and may be electrical or adopt other forms.

The modules described as separate parts may or may not be physically separated, and parts displayed as modules may or may not be physical modules, and namely may be located in the same place, or may also be distributed to multiple network modules. Part or all of the modules may be selected to achieve the purpose of the solutions of the embodiments according to a practical requirement.

In addition, each function module in each embodiment of the disclosure may be integrated into a processing module, each module may also physically exist independently, and two or more than two modules may also be integrated into a module. The integrated module may be implemented in a hardware form and may also be implemented in form of a software function module.

When being implemented in form of software functional module and sold or used as an independent product, the integrated module may be stored in a computer-readable memory. Based on such an understanding, the technical solutions of the disclosure substantially or parts making contributions to the conventional art or all or part of the technical solutions may be embodied in form of software product, and the computer software product is stored in a memory, including a plurality of instructions configured to enable a computer device (which may be a personal computer, a server, a network device or the like) to execute all or part of the steps of the method in each embodiment of the disclosure. The abovementioned memory includes: various media capable of storing program codes such as a U disk, a Read-Only Memory (ROM), a Random Access Memory (RAM), a mobile hard disk, a magnetic disk or an optical disk.

Those of ordinary skill in the art can understand that all or part of the steps in various methods of the embodiments may be completed by related hardware instructed by a program, the program may be stored in a computer-readable memory, and the memory may include a flash disk, a ROM, a RAM, a magnetic disk, an optical disk or the like.

The embodiments of the application are introduced above in detail, the principle and implementation modes of the disclosure are elaborated with specific examples in the disclosure, and the descriptions made to the embodiments are only adopted to help the method of the disclosure and the core concept thereof to be understood. In addition, those of ordinary skill in the art may make variations to the specific implementation modes and the application scope according to the concept of the disclosure. From the above, the contents of the specification should not be understood as limits to the disclosure.

1. An image processing method, comprising:
acquiring a moving image and a fixed image used for registration;
inputting the moving image and the fixed image to a preset neural network model, a target function for similarity measurement in the preset neural network model comprising a loss of a correlation coefficient for a preset moving image and a preset fixed image; and
registering the moving image to the fixed image based on the preset neural network model to obtain a registration result.

2. The image processing method of claim 1, before acquiring the moving image and the fixed image used for registration, further comprising:
acquiring an original moving image and an original fixed image, and performing image normalization processing on the original moving image and the original fixed image to obtain a moving image and fixed image meeting a target parameter.

3. The image processing method of claim 2, wherein performing image normalization processing on the original moving image and the original fixed image to obtain the moving image and fixed image meeting the target parameter comprises:
converting the original moving image to a moving image with a preset image size and in a preset gray value range; and
converting the original fixed image to a fixed image with the preset image size and in the preset gray value range.

4. The image processing method of claim 1, wherein a training process for the preset neural network model comprises:
acquiring the preset moving image and the preset fixed image, and inputting the preset moving image and the preset fixed image to the preset neural network model to generate a deformable field;
registering the preset moving image to the preset fixed image based on the deformable field to obtain a moved image;
obtaining a loss of a correlation coefficient for the moved image and the preset fixed image; and
performing parameter updating on the preset neural network model based on the loss of the correlation coefficient to obtain a trained preset neural network model.

5. The image processing method of claim 4, after acquiring the preset moving image and the preset fixed image, further comprising:
performing image normalization processing on the preset moving image and the preset fixed image to obtain a preset moving image and preset fixed image meeting a preset training parameter, wherein
inputting the preset moving image and the preset fixed image to the preset neural network model to generate the deformable field comprises:
inputting the preset moving image and preset fixed image meeting the preset training parameter to the preset neural network model to generate the deformable field.

6. The image processing method of claim 5, further comprising:
converting a size of the preset moving image and a size of the preset fixed image to the preset image size, wherein
performing image normalization processing on the preset moving image and the preset fixed image to obtain the preset moving image and preset fixed image meeting the preset training parameter comprises:
processing the converted preset moving image and the converted preset fixed image according to a target window width to obtain a processed preset moving image and a processed preset fixed image.

7. The image processing method of claim 6, before processing the converted preset moving image and the converted preset fixed image according to the target window width, further comprising:
acquiring a target category label of the preset moving image, and
determining the target window width corresponding to the target category label according to a corresponding relationship between a preset category label and a preset window width.

8. The image processing method of claim 5, further comprising:
performing, based on a preset optimizer, parameter updating for a preset learning rate and a preset threshold count on the preset neural network model.

9. An electronic device, comprising a processor and a memory, wherein the memory is configured to store one or more programs, when the one or more programs are executed by the processor, the processor is configured to:
acquire a moving image and a fixed image used for registration;
input the moving image and the fixed image to a preset neural network model, a target function for similarity measurement in the preset neural network model comprising a loss of a correlation coefficient for a preset moving image and a preset fixed image; and
register the moving image to the fixed image based on the preset neural network model to obtain a registration result.

10. The electronic device of claim 9, wherein the processor is further configured to acquire an original moving image and an original fixed image and perform image normalization processing on the original moving image and the original fixed image to obtain a moving image and fixed image meeting a target parameter.

11. The electronic device of claim 10, wherein the processor is specifically configured to:
convert the original moving image to a moving image with a preset image size and in a preset gray value range; and
convert the original fixed image to a fixed image with the preset image size and in the preset gray value range.

12. The electronic device of claim 9, wherein the processor is further configured to:
acquire the preset moving image and the preset fixed image and input the preset moving image and the preset fixed image to the preset neural network model to generate a deformable field;
register the preset moving image to the preset fixed image based on the deformable field to obtain a moved image; and
obtain a loss of a correlation coefficient for the moved image and the preset fixed image, and is configured to perform parameter updating on the preset neural network model based on the loss of the correlation coefficient to obtain a trained preset neural network model.

13. The electronic device of claim 12, wherein the processor is further configured to:
perform image normalization processing on the preset moving image and the preset fixed image to obtain a preset moving image and preset fixed image meeting a preset training parameter; and
the processor is specifically configured to input the preset moving image and preset fixed image meeting the preset training parameter to the preset neural network model to generate the deformable field.

14. The electronic device of claim 13, wherein the processor is specifically configured to:
convert a size of the preset moving image and a size of the preset fixed image to the preset image size; and
process the converted preset moving image and the converted preset fixed image according to a target window width to obtain a processed preset moving image and a processed preset fixed image.

15. The electronic device of claim 14, wherein the processor is further configured to:
before the converted preset moving image and preset fixed image are processed according to a preset window width, acquire a target category label of the preset moving image and determine the target window width corresponding to the target category label according to a corresponding relationship between a preset category label and a preset window width.

16. The electronic device of claim 13, wherein the processor is further configured to:
perform, based on a preset optimizer, parameter updating for a preset learning rate and a preset threshold count on the preset neural network model.

17. A computer readable storage medium, configured to store computer programs for electronic data exchange, the computer programs enabling a computer to perform the following operations:
acquiring a moving image and a fixed image used for registration;
inputting the moving image and the fixed image to a preset neural network model, a target function for similarity measurement in the preset neural network model comprising a loss of a correlation coefficient for a preset moving image and a preset fixed image; and
registering the moving image to the fixed image based on the preset neural network model to obtain a registration result.

18. The computer readable storage medium of claim 17, before acquiring the moving image and the fixed image used for registration, further comprising:
acquiring an original moving image and an original fixed image, and performing image normalization processing on the original moving image and the original fixed image to obtain a moving image and fixed image meeting a target parameter.

19. The computer readable storage medium of claim 18, wherein performing image normalization processing on the original moving image and the original fixed image to obtain the moving image and fixed image meeting the target parameter comprises:
converting the original moving image to a moving image with a preset image size and in a preset gray value range; and
converting the original fixed image to a fixed image with the preset image size and in the preset gray value range.

20. The computer readable storage medium of claim 17, wherein a training process for the preset neural network model comprises:
acquiring the preset moving image and the preset fixed image, and inputting the preset moving image and the preset fixed image to the preset neural network model to generate a deformable field;
registering the preset moving image to the preset fixed image based on the deformable field to obtain a moved image;
obtaining a loss of a correlation coefficient for the moved image and the preset fixed image; and
performing parameter updating on the preset neural network model based on the loss of the correlation coefficient to obtain a trained preset neural network model.
